(19) United States
(12) Patent Application Publication
(10) Pub. No.: US 2015/0007352 A1
(43) Pub. Date: Jan. 1, 2015

(54) COPY LIMITATION MANAGEMENT DEVICE AND METHOD, AND CONTENT STORAGE DEVICE

(71) Applicant: Kabushiki Kaisha Toshiba, Tokyo (JP)

(72) Inventors: Shinichi Kurihara, Yokohama-shi (JP); Sunao Wada, Yokohama-shi (JP); Yasuo Ooya, Tokyo (JP); Junji Hiroshima, Nagareyama-shi (JP); Takafumi Abe, Fuchu-shi (JP)

(21) Appl. No.: 14/490,599

(22) Filed: Sep. 18, 2014

Related U.S. Application Data
(63) Continuation of application No. 12/363,184, filed on Jan. 30, 2009.

(30) Foreign Application Priority Data
Feb. 22, 2008 (JP) 2008041866

(51) Int. Cl. G06F 21/60; G06F 21/79

(52) U.S. Cl. CPC G06F 21/604; G06F 21/79
USPC 726/31

(57) ABSTRACT

A content storage device comprises a content storage unit which stores master content with content handling information including conditions of copy limitations added thereto, content information management units which acquire to individually manage content information related to the conditions of the copy limitations from the content handling information added to the stored content in storing the master content, a content information provision unit which reads to provide management information in response to a request, and a copy limitation processing unit which determines the conditions of the copy limitations from the management information of the content information management unit in copy requesting of the master content and instructs execution of copy processing only when the conditions are satisfied, and updates the conditions of the copy limitations in accordance with instructing execution of the copy processing.

### CROSS-REFERENCE TO RELATED APPLICATIONS

This application is based upon and claims the benefit of priority from prior Japanese Patent Application No. 2008-041866, filed Feb. 22, 2008, the entire contents of which are incorporated herein by reference.

### BACKGROUND OF THE INVENTION

1. Field of the Invention

The invention relates to a copy limitation management device and method which manages handling related to copy for content with the copy limitations imposed thereon, such as content of digital broadcast program, and a content storage device which adopts the method as a function.

2. Description of the Related Art

Recently, as broadband spreads and its communication rate increases, services, which use communication lines to deliver pre-stored content in response to requests, have appeared. Meanwhile, even in general homes, systems which store program content received through broadcast radio waves or broadband, copy the stored program content to recording media to listen by means of other sets of reproduction equipment have become widely used, with such a situation in mind, content which has been primarily stored is recognized as master content, and copy limitations so as to permit only movement in principle have been imposed. However, in a case of the limitations permitting only the movement, master content may be eliminated due to troubles of the reproduction equipment or information recording media, etc., and resulting disadvantages are caused to users. Therefore, cases of limitations of the number of timers of copies including backup copies become frequent.

When making copies of master content with copy limitations to sets of other equipment or information recording media, it is necessary to correctly manage the number of times of copies. Systems are required, which transfer and present content information, what content with copy limitations exists, and how many times of copies is permitted. If the limitations of the number of times of delivery permission are imposed also on content delivery agents, it is necessary to correctly manage the number of times of copies from the master content.

An example of copy processing of content with conventional copy limitations imposed thereon is disclosed in Jpn. Pat. Appln. KOKAI Publication No. 2007-124475 and Jpn. Pat. Appln. KOKAI Publication No. 2003-022338.

That is, in Jpn. Pat. Appln. KOKAI Publication No. 2007-124475, a method, which imposes limitations on the next copying for the same content as that has already been copied, or on original content on the recording medium that is an source of copying for every copying at the recording device when it is permitted to make copies by the prescribed number of times, is disclosed.

In Jpn. Pat. Appln. KOKAI publication No. 2003-022338, a technique, which stores information on the number of times of copying control of the content at the copy source, updates the number of copyable times control information stored in the copy source before copy processing in accordance with a fixed rule when the content is copied from the copy source to a copy destination, generates the number of copyable times control information to be stored in the copy source and the number of copyable times control information to be stored in the copy destination, performs copy processing at the copy source after the generation on the basis of the number of copyable times control information stored in the copy source, and performs the copy processing for the content recorded on the recording medium after the generation on the basis of the number of copyable times control information recorded on the recording medium, is disclosed.

As described above, the conventional content storage device does not have a function of appropriately managing conditions of copy limitations for the stored content with copy limitations, and the user has to confirm the information about conditions of copy limitations and the remaining number of copyable times imposed on the content for each copying of the content.

### BRIEF SUMMARY OF THE INVENTION

An object of the invention is to provide a copy limitations management device and a method, and content storage device which is configured to appropriately and integrally manage information about copy limitations for each item of stored content with copy limitations and present a situation of the copy limitations to a user.

According to the present invention, there is provided a copy limitations management device, comprising: content information management module to acquire at least content information related to the conditions of the copy limitations from the content handling information added to storage content in storing the master content to manage the content information for each storage content; content information provision module which reads to provide content information of specified content from the content information management module in response to a request; and copy limitation processing module to determine the conditions of the copy limitations of the content information managed by the content information management module in copy requesting of the master content, disabling copying if the conditions are not satisfied, and instructing execution of copy processing if the conditions are satisfied, wherein the content information management module updates the conditions of the copy limitations while instructing the execution of the copy processing of the copy limitation processing module.

According to the present invention, there is provided a copy limitations management method, comprising: acquiring at least content information related to the conditions of the copy limitations from the content handling information added to storage content in storing the master content to manage the content information for each storage content; providing content information of content during the management in response to a request; determining the conditions of the copy limitations from content information of content during the management in requesting copying of the master content, disabling copying if the conditions are not satisfied, and executing copy processing if the conditions are satisfied; and updating the conditions of the copy limitations when the copy processing is completed.

According to the present invention, there is provided a content storage device, comprising: content storage module to store master content with content handling information including conditions of copy limitations added thereto; content information management module to acquire at least content information related to the conditions of the copy limitations from the content handling information added to the stored content in storing the master content; content information provision module which reads to provide content information of specified content from the content information management module in response to a request; and copy limitation processing module to determine the conditions of the copy limitations of the content information managed by the content information management module in copy requesting of the master content, disabling copying if the conditions are not satisfied, and instructing execution of copy processing if the conditions are satisfied, wherein the content information management module updates the conditions of the copy limitations while instructing the execution of the copy processing of the copy limitation processing module.

That is, the invention generates to manage information related to handling how master content with copy limitations is limited (copy disablement, copyable by nine times, output disablement to another equipment, etc.) when the master content with copy limitations is stored.

When the content is limited in the number of copyable times, etc., for making a copy on another equipment of an information recording medium, the invention manages limitation information so as to count up the number of times of copying from the master content on the basis of the information managed in the manner given above and disable the copying when the resulting count-up reaches an upper limit.

When connecting another set of equipment, via a communication line, to the terminal with the master content with copy limitations stored therein to intend cooperation of content, the invention provides information showing what content exists and what limitations are imposed, accepts selection by the user, and enables copying the content.

At this time, at the terminal on the reception side, the limitation of copy disablement is imposed. Thereby, the invention can correctly manages the number of times at which the master content with copy limitations is copied to another set of equipment, or to information recording media, make copies, and improve the convenience by selecting the content on the basis of content information showing what content with copy limitations exists and how many times the content is copyable for each terminal.

According to the invention, the copy limitation management device and its method, and the content storage device configured to appropriately and integrally manage the information relating to copy limitations for each item of stored content with copy limitations and present the situation of the copy limitations to the user.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary block diagram depicting an embodiment of a system using a content storage device of the invention;

FIG. 2 is an exemplary view depicting an example of a content information display of the system shown in FIG. 1;

FIG. 3 is an exemplary flowchart depicting a processing flow of a content handling information processing unit of a master side device for use in the system shown in FIG. 1;

FIG. 4 is an exemplary flowchart depicting a processing flow of the content limitation information processing unit of the master side device for the use in the system shown in FIG. 1;

FIG. 5 is an exemplary sequence view depicting communication processing between content information acquisition unit of a slave side device and a content information service unit of the master side device used in the system shown in FIG. 1; and

FIG. 6 is an exemplary sequence view depicting communication processing between the content information acquisition unit of the slave side device and the content information service of the master side device which follow the FIG. 5.

### DETAILED DESCRIPTION OF THE INVENTION

Hereinafter, embodiments of the invention will be described in detail with reference to the drawings.

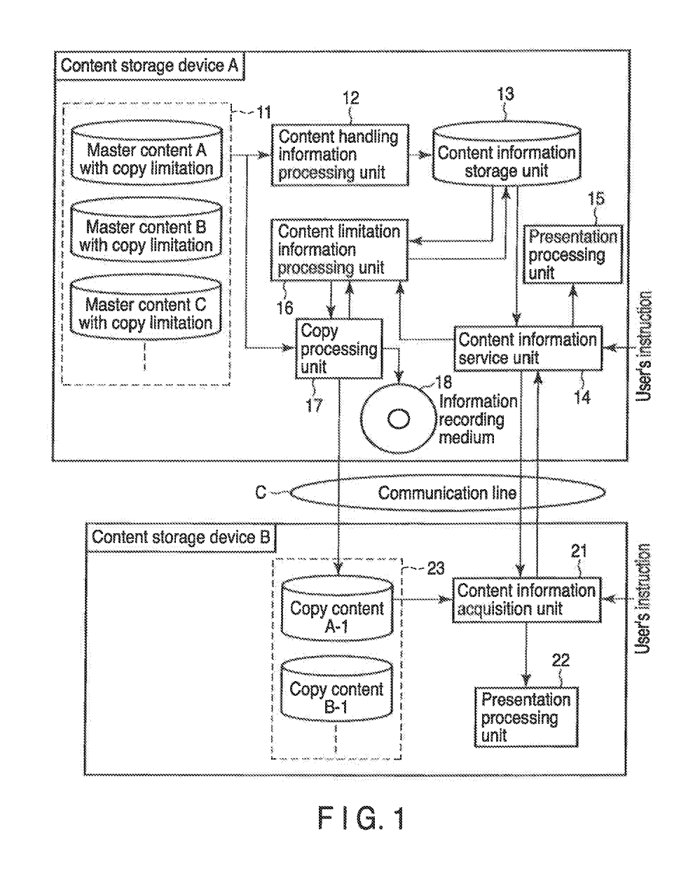

FIG. 1 shows a block diagram depicting an embodiment of a system using a content storage device of the invention. In FIG. 1, the content storage device includes a master side content storage device (a master side device) A and a slave side content storage device (a slave side device) B, and the master side device A and the slave side device B are connected to each other via a communication line C. The communication line C may any one of a public telephone line, a LAN and a home network.

The master side device A comprises a content storage unit 11, a content handling information processing unit 12, a content information storage unit 13, a content information service unit 14, a presentation processing unit 15, a content limitation information processing unit 16, a copy processing unit 17, and an information recording medium recording and reproduction unit 18. While not showing in FIG. 1, the master side device A includes a content acquisition unit which selects to receive content provided through a terrestrial digital broadcast, a BS digital broadcast, an Internet Protocol (IP) broadcast, a network download, etc. The content acquisition unit itself may be disposed outside the master side device A.

The master side device A stores the content acquired by the selection and reception of the content provided through the terrestrial digital broadcast, BS digital broadcast, IP broadcast, network download, etc., as master content, in the content storage unit 11. Here, content handling information including copy limitations is added to the acquired content.

The content handling information processing unit 12 acquires the content handling information from the master content stored in the content storage unit 11, determines, from the content handling information, whether or not the content is at least one which can be copied, or whether how many times the copying is permitted if the content can be copied, and stores a determination result, as handling and limitation information, in the content information storage unit 13. At this time, if necessary, the storage unit 13 stores content related information, such as identification information (terrestrial digital broadcast waves, BS digital broadcast waves, IP broadcast, network download, etc.) in an acquisition form from the externally specified information, source information of the content, acquisition time zones, title names, outlines, performers, volumes, hours, information output permission and condition information to another content storage device, and information required to associated with objective content, together with handling and limitation information, as the content information.

The content information service unit 14 receives an output request of the content information based on a user's instruction input, acquires the information of the content required from the content information storage unit 13, and issues to present the information of the content on the presentation processing unit 15.

The service unit 14 receives an output request of the content information from another content storage device B via the communication line C, acquires the information of the content required from the storage unit 13, and issues the information of the content to a request source. At this moment, the service unit 14 issues the number of copyable times in addition to the title name, etc., as the content information.

The service unit 14 receives content copy requests to information recording medium (a DVD-RAM, DVD-R/W, DVD-R, DVD+R, DVD+R/W, CD-R, CD-RW, IC card [SD], etc.) based on the user's instruction input, or content copy requests from another content storage device B via the communication line C, acquires the handling and limitation information of the required content from the storage unit 13 to determine whether the copying is disabled or not disabled, and if it is not disabled, instructs a copy destination to the content limitation information processing unit 16 to make a copy issue request by instructing the copy destination. Here, as regards the determination whether the copying is disabled or not disabled, at least confirmation whether or not the remaining number of copyable times has reached an upper limit is performed.

The information processing unit 16 receives the copy issue request from the service unit 14, acquires the information of the corresponding-content from the storage unit 13, counts up the number of copyable times to rewrite the content handling and limitation information of the storage unit 13, and also instructs the copy processing unit 17 on copy processing of the required content. Here, if the number of copyable times reaches the upper limit due to count-up, the information processing unit 16 disables the copying after this and makes the copy processing unit 17 enable to specify only the “movement”.

The copy processing unit 17 reads the corresponding-content from the content storage unit 11 on the basis of the instruction from the information processing unit 16, rewrites the number of copy permission times of the content handling information to “0”, and delivers the read content to the specified copy destination, namely, information recording medium recording and reproduction unit 18 or request source content storage device B. After completion of copying, the copy processing unit 17 issues processing completion report to the content limitation information processing unit 16 to fix the count-up. After reaching the upper limit, if the “movement” is specified, the copy processing unit 17 deletes copy source content stored in the content storage unit 11 after the completion of the copying.

Meanwhile, the slave side device B includes a content information acquisition unit 21, a presentation processing unit 22 and a content storage unit 23.

The information acquisition unit 21 confirms the presence of another content storage device (the master side device) A capable of providing the content information via the communication line C, accesses the service unit 14 of the master side device A in response to the user's instruction input, issues the content information output request to acquire the content information, and makes the presentation processing unit 22 present the content information. Here, the information acquisition unit 21 may display the devices capable of proving the content information through the communication line C in a list form, and after selecting the devices, and may cooperate with the content information service unit of the selected device to acquire the content information. Other than this, the information acquisition unit 21 acquires the content information of the content stored in the content storage unit 23 from the storage unit 23 in the self device in response to the user's instruction input, and makes the presentation processing unit 22 present the content information.

The information acquisition unit 21 receives the content acquisition request from the source of the content information in response to the user's instruction input, connects to the corresponding-content storage device (master side device A), and issues a content datively request to the information service unit 14.

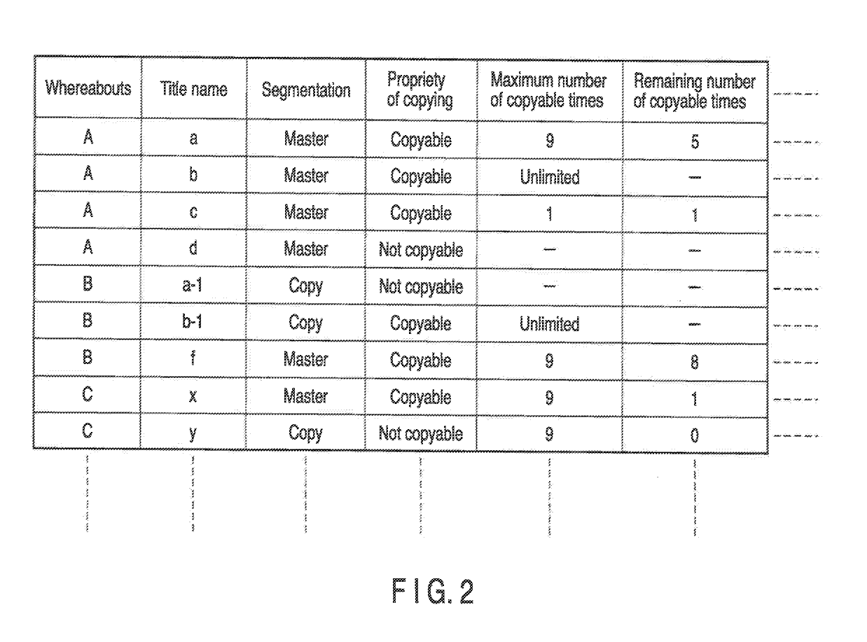

The presentation processing unit 22 acquires the content information from the information acquisition unit 21 to issue the content information to a presentation device such as a display unit (not shown). FIG. 2 shows an example of a display on the display unit. In the example, whereabouts of content (A, B, C, . . . ), title names (a, b, c, . . . ), segmentations (master or copy), proprieties of copying (copyable, not copyable), maximum number of copyable times, and remaining number of copyable times are shown. The user determines, from the displayed table, which content is stored in which device, and can easily recognize the propriety of copying and the number of copying times.

The presentation processing unit 22 receives a content audio-visual request to issue the request to a presentation device such as a display unit. If the content has been encrypted, the presentation processing unit 22 performs decryption processing. In this case, the presentation processing unit 22 may acquire key information in order to decrypt the encryption of the objective content into the content information acquired by the information acquisition unit 21.

It is preferable for each processing which has been separately described in the content storage device A and the content storage device B to exist together in one terminal device.

In the foregoing configuration, the following will describe a processing operation of each constituent element.

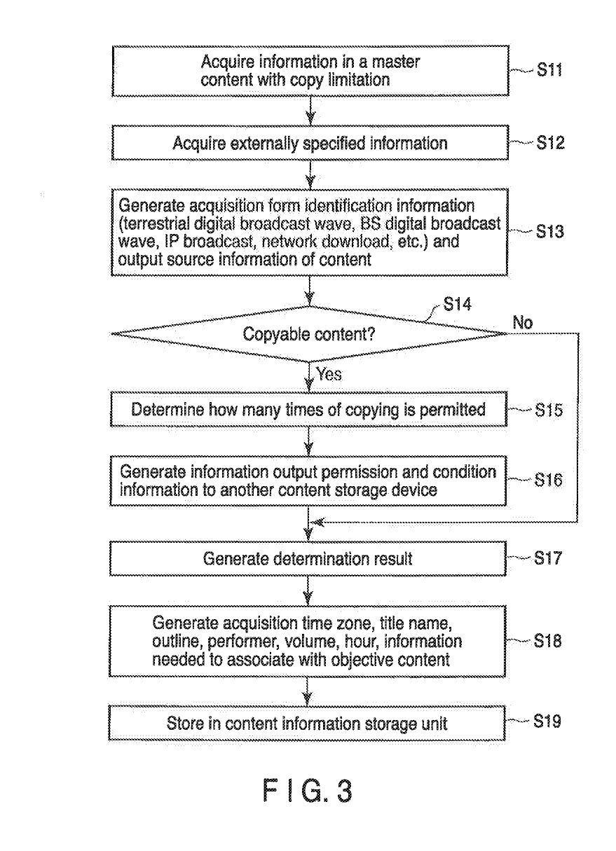

FIG. 3 shows a flowchart depicting the processing flow of the content handling information processing unit 12 of the master side device A. In FIG. 3, when the information processing unit 12 stores the master content with copy limitations in the content storage unit 11, the information processing unit 12 acquires the information in the content (Step S11), and in addition to this, the processing unit 12 acquires the externally specified information (Step S12). The processing unit 12 then generates the acquisition form identification information (terrestrial digital broadcast waves, BS digital broadcast waves, IP broadcast, network download, etc.) and output source information of the content from the acquired information (Step S13).

Here, the processing unit 12 determines whether or not the content is copyable (Step S14), if the content is copyable, the processing unit determines haw many times of the copying is permitted (Step S15), and generates information of output permission and conditions to another content storage device (Step S16).

After the aforementioned determination, the processing unit 12 generates a determination result (Step S17), generates acquisition time zones, title names, outlines, performers, volumes, hours, and information required to associate with the objective content (Step S18) to store them in the content information storage unit 13 (Step S19).

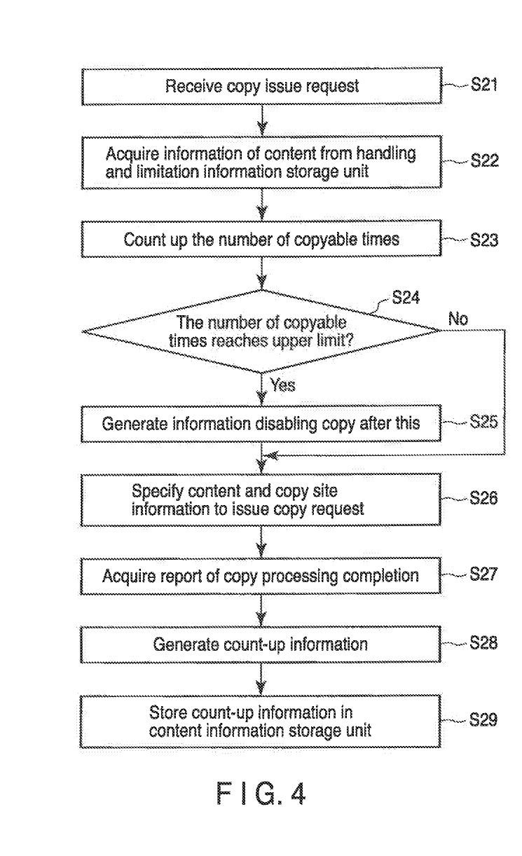

FIG. 4 is a flowchart depicting a processing flow of the content limitation information processing unit 16 of the master side device A. In FIG. 4, when the information processing unit 16 receives the copy issue request (Step S21), the information processing unit 16 acquires information of the corresponding-content from the information storage unit 13 (Step S22), and counts up the number of copyable times (Step S23). Here, the information processing unit 16 determines whether the number of copyable times reaches an upper limit (Step S24). And if the number of copyable times reaches the upper limit, the information processing unit 16 generates the information in order to disable copying after this (Step S25).

The information processing unit 16 then specifies the corresponding-content and copy site information to issue the copy request to the copy processing unit 17 (Step S26). Here, the information processing unit 16 specifies, as the copy site information, the information of the information recording medium (the DVD-RAM, DVD-R/W, DVD-R, CD-RW, IC card [SD], etc.) 17 connected or set to its own terminal, or the information of another content storage device B via the communication line C. When acquiring the copy processing completion report from the copy processing unit 17 (Step S27), the information processing unit 16 generates count-up information (Step S28), and stores the count-up information in the handling and limitation information storage unit 13 (Step S29).

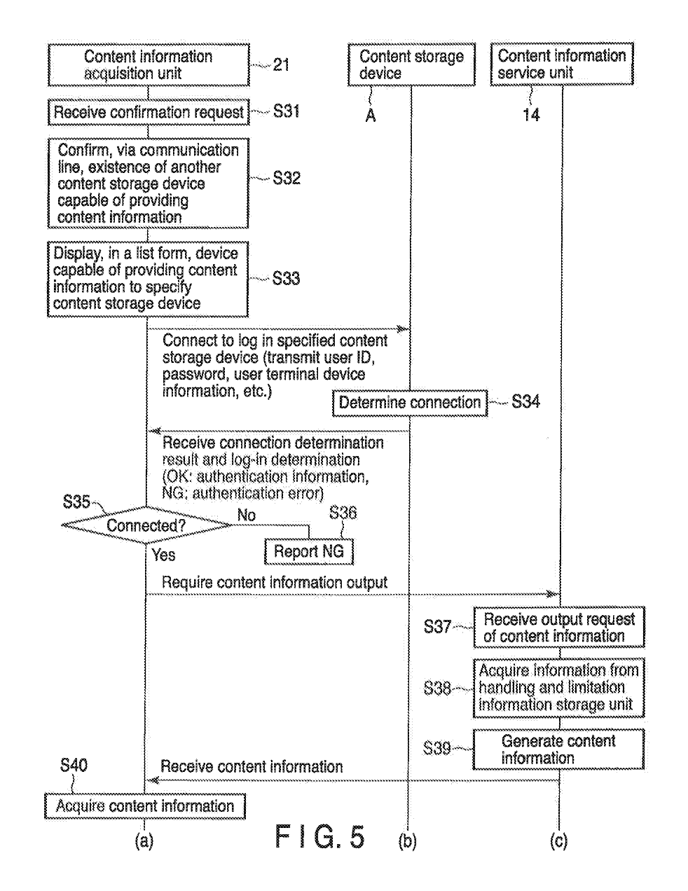

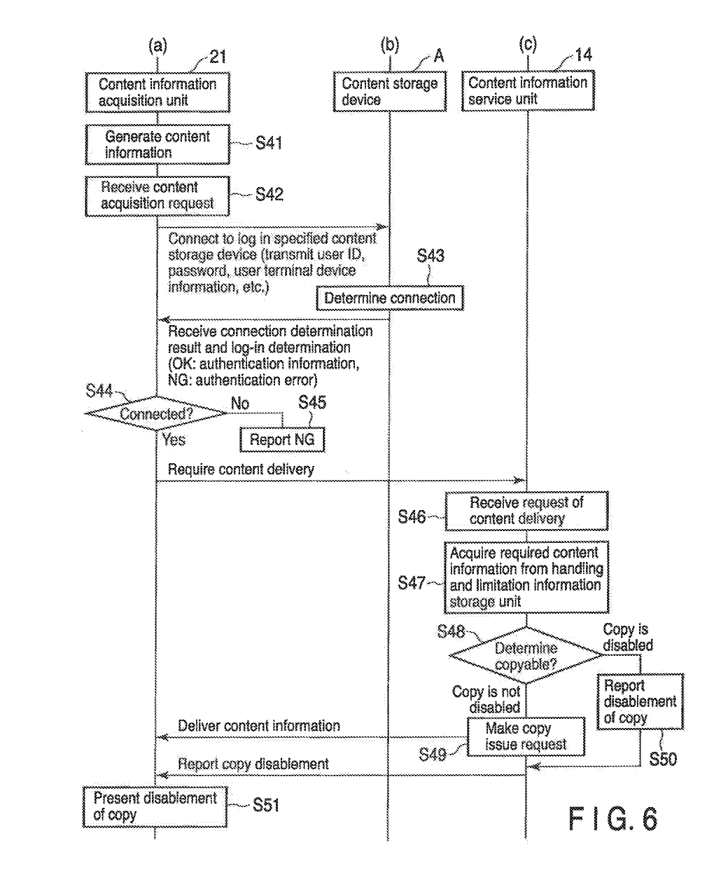

FIGS. 5 and 6 are sequence views each depicting communication processing between the content information acquisition unit 21 of the slave side device B and the content information service unit 14 of the master side device A.

In FIG. 5, when the information acquisition unit 21 receives the confirmation request from the user's instruction input (Step S31), the information acquisition unit 21 confirms the existence of another content storage device (master side device A) capable of providing the content information via the communication line C (Step S32), displays, in a list form, the devices capable of providing the content information, receives the specification of the content storage device from the user, and connects to log in the specified content storage device (transmits user ID, password, user terminal device information, etc.) (Step S33). When connection determination is performed at a partner's side device (Step S34), and receiving the connection determination result (“OK”: authentication information, “NG”: authentication error), the information processing unit 16 determines the propriety of connection (Step S35), if the connection is disabled, reports “NG” (Step S36), and if the connection is not disabled, requires the content information output to the content information device unit 14 of the partner's side device.

When receiving the output request of the content information (step S37), the information service unit 14 acquires the corresponding-information from the information storage unit 13 (Step S38), and generates the content information (title names, the number of copyable times, etc.) in a prescribed form to report the content information to the request source (Step S39).

When the content information acquisition unit 21 receives content information from the information service unit 14 (Step S40), the information acquisition unit 21, as shown in FIG. 6, generates a content information list by putting the content information of the content stored in the content storage unit 23 in its own device together, and presents the list in the form shown in FIG. 2 (Step S41). When receiving the content acquisition request by means of the user's instruction input (Step S42), the information acquisition unit 21 connects itself to the concerned content storage device to log in the storage device (transmits the user ID, password, user terminal device information, etc.). The partner's side device determines the connection (Step S43), when receiving the log-in determination result (“OK”: authentication information, “NG”: authentication error), the information acquisition unit 21 determines the propriety of connection (Step S44), if the connection is disabled, reports “NG” (step S45), and if the connection is not disabled, requires the content delivery to the information service unit 14 of the partner's side device.

When the information service unit 14 receives the content delivery request (Step S46), the information service unit 14 acquires the information of the required content from the information storage unit 13 (Step S47), and determines the propriety of copying (Step S48). If the copying is not disabled, the information service unit 14 generates the copying issue request to send it to the copy processing unit 17, and makes the copy processing unit 17 execute copy processing (content delivery) (Step S49). If the copying is disabled, the information service unit 14 reports the disablement of the copying to the information acquisition unit 21 (Step S50). When receiving the report of the disablement of the copying, the information acquisition unit 21 makes the presentation processing unit 22 present the disablement of the copying (Step S51).

With the aforementioned processing performed, copy management of the master content is integrally managed for both its own device and another device; any one of its own device and another device may present the content information in response to the user's request.

Thereby, as regards each of the stored content with copy limitations, the information of the copy limitations may be appropriately and integrally managed, and the situation of the copy limitations may be presented to the user.

While the aforementioned embodiment has been described that the master side device A and the slave side device B are different from each other, they may be integrated as one device. While the master side device A has been described as the content storage device, the master side device A can be used as a copy limitation management device by separating a copy limitation management part of the content.

Further, the invention is not limited to the specific details and representative embodiments shown and described herein, and in an implementation phase, this invention may be embodied in various forms without departing from the spirit or scope of the general inventive concept thereof. Various types of the invention can be formed by appropriately combining a plurality of constituent elements disclosed in the foregoing embodiments. Some of the elements, for example, may be omitted from the whole of the constituent elements shown in the embodiments mentioned above. Further, the constituent elements over different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1-16. (canceled)

17. A copy limitation management device comprising:
a content handling information processing unit configured such that, when a master content added with content handling information including copy limitation information is stored in a first content storage device, the content handling information processing unit reads the content handling information from the first content storage device and acquires content information including the copy limitation information based on the content handling information;
a content information storage unit configured to store the content information;
a content information service unit configured such that
when a first request for content information output is received from a second content storage device, the content information service unit reads the content information from the content information storage unit and outputs the content information to the second content storage device, and
when a second request for master content delivery is received from the second content storage device, the content information service unit reads content information of a designated master content according to the second request from among the content information stored in the content information storage unit, determines whether the designated master content is copiable or not based on copy limitation information included in the read content information, and generates a copy issue request if the designated master content is copiable;
a content limitation information processing unit configured to, responsive to the copy issue request, read the content information of the designated master content from the content information storage unit, update the copy limitation information included in the read content information, and generate a copy request; and
a copy processing unit configured to, responsive to the copy request, read the designated master content from the first content storage device, and deliver the read master content to the second content storage device.

18. The device of claim 17, wherein:
the content limitation information processing unit updates a number of copiable times as the copy limitation information, each time the copy issue request is generated.

19. The device of claim 18, wherein:
when the updated number of copiable times reaches a predetermined number, the content limitation information processing unit updates the copy limitation information included in the read content information so that copying of the designated master content is disabled.

20. The device of claim 18, wherein:
when the updated number of copiable times reaches a predetermined number, the content limitation information processing unit updates the copy limitation information included in the read content information so that only movement of the designated master content can be requested.

21. The device of claim 17, wherein:
when a third request for master content copying in a storage medium is received, the content information service unit reads content information of a designated master content according to the third request from among the content information stored in the content information storage unit, determines whether the designated master content is copiable or not based on the copy limitation information included in the read content information, and generates a copy issue request if the designated master content is copiable, and
responsive to the copy request generated by the content limitation information processing unit, the copy processing unit reads the designated master content from the first content storage device, and makes a copy of the read master content in the storage medium.

22. The device of claim 17, further comprising:
a presentation processing unit configured to display the content information read by the content information service unit.

23. The device of claim 17, wherein:
the copy processing unit generates a completion report upon completion of delivery of the read master content to the second content storage device, and
responsive to the completion report, the content limitation information processing unit fixes update of the copy limitation information included in the read content information.

24. The device of claim 17, wherein:
the copy processing unit imposes copy limitation on the read master content when delivering the read master content to the second content storage device.

25. A copy limitation management method comprising:
when a master content added with content handling information including copy limitation information is stored in a first content storage device, reading the content handling information from the first storage device and acquiring content information including the copy limitation information based on the content handling information;
storing the content information in a content information storage unit;
when a first request for content information output is received from a second content storage device,
reading the content information from the content information storage unit, and
outputting the content information to the second content storage device; and
when a second request for master content delivery is received from the second content storage device,
reading content information of a designated master content according to the second request from among the content information stored in the content information storage unit,
determining whether the designated master content is copiable or not based on copy limitation information included in the read content information, and
generating a copy issue request if the designated master content is copiable;
responsive to the copy issue request, reading the content information of the designated master content from the content information storage unit, updating the copy limitation information included in the read content information, and generating a copy request; and
responsive to the copy request, reading the designated master content from the first content storage device, and delivering the read master content to the second content storage device.

26. The method of claim 25, wherein:
said updating the copy limitation information comprises updating a number of copiable times as the copy limitation information, each time the copy issue request is generated.

27. The method of claim 26, wherein:
said updating the copy limitation information comprises, when the updated number of copiable times reaches a predetermined number, updating the copy limitation information included in the read content information so that copying of the designated master content is disabled.

28. The method of claim 26, wherein:
said updating the copy limitation information comprises, when the updated number of copiable times reaches a predetermined number, updating the copy limitation information included in the read content information so that only movement of the designated master content can be requested.

29. The method of claim 25, further comprising:
when a third request for master content copying in a storage medium is received,
reading content information of a designated master content according to the third request from among the content information stored in the content information storage unit,
determining whether the designated master content is copiable or not based on copy limitation information included in the read content information, and
generating a copy issue request if the designated master content is copiable;
responsive to the copy issue request, reading the content information of the designated master content from the content information storage unit, updating the copy limitation information included in the read content information, and generating a copy request, and
responsive to the copy request, reading the designated master content from the first content storage device, and making a copy of the read master content in the storage medium.

30. The method of claim 25, further comprising:
generating a completion report upon completion of delivery of the read master content to the second content storage device, and
responsive to the completion report, fixing update of the copy limitation information included in the read content information.

31. The method of claim 25, further comprising:
imposing copy limitation on the read master content when delivering the read master content to the second content storage device.

32. A content storage device comprising:
a content storage unit configured to store a master content added with content handling information including copy limitation information;
a content handling information processing unit configured such that, when the master content is stored in the content storage unit, the content handling information processing unit reads the content handling information from the content storage unit and acquires content information including the copy limitation information based on the content handling information;
a content information storage unit configured to store the content information;
a content information service unit configured such that
when a first request for content information output is received from an external device, the content information service unit reads the content information from the content information storage unit and outputs the content information to the external device, and
when a second request for master content delivery is received from the external device, the content information service unit reads content information of a designated master content according to the second request from among the content information stored in the content information storage unit, determines whether the designated master content is copiable or not based on copy limitation information included in the read content information, and generates a copy issue request if the designated master content is copiable;
a content limitation information processing unit configured to, responsive to the copy issue request, read the content information of the designated master content from the content information storage unit, update the copy limitation information included in the read content information, and generate a copy request; and
a copy processing unit configured to, responsive to the copy request, read the designated master content from the content storage unit, and deliver the read master content to the external device.

33. The device of claim 32, wherein:
the content limitation information processing unit updates a number of copiable times as the copy limitation information, each time the copy issue request is generated,

34. The device of claim 33, wherein:
when the updated number of copiable times reaches a predetermined number, the content limitation information processing unit updates the copy limitation information included in the read content information so that copying of the designated master content is disabled.

35. The device of claim 33, wherein:
when the updated number of copiable times reaches a predetermined number, the content limitation information processing unit updates the copy limitation information included in the read content information so that only movement of the designated master content can be requested.

36. The device of claim 32, wherein:
when a third request for master content copying in a storage medium is received, the content information service unit reads content information of a designated master content according to the third request from among the content information stored in the content information storage unit, determines whether the designated master content is copiable or not based on the copy limitation information included in the read content information, and generates a copy issue request if the designated master content is copiable, and
responsive to the copy request generated by the content limitation information processing unit, the copy processing unit reads the designated master content from the content storage unit, and makes a copy of the read master content in the storage medium.

37. The device of claim 32, further comprising:
a presentation processing unit configured to display the content information read by the content information service unit.

38. The device of claim 32, wherein:
the copy processing unit generates a completion report upon completion of delivery of the read master content to the external device, and
responsive to the completion report, the content limitation information processing unit fixes update of the copy limitation information included in the read content information.

39. The device of claim 32, wherein:
the copy processing unit imposes copy limitation on the read master content when delivering the read master content to the external device.
